(19) United States
(12) Patent Application Publication
(10) Pub. No.: US 2005/0242607 A1
(43) Pub. Date: Nov. 3, 2005

(54) Lining element for the interior of a vehicle

(75) Inventor: Michael Neumann, Leverkusen (DE)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/525,782

(22) PCT Filed: Aug. 14, 2003
(86) PCT No.: PCT/EP03/09019

§ 371 Date: Feb. 28, 2005

(30) Foreign Application Priority Data
Aug. 31, 2002 (DE) DE 10240270.1

(51) Int. Cl. B60R 13/01

(52) U.S. Cl. 296/39.1

(57) ABSTRACT

In a lining element (1) for the interior of a vehicle, in particular a motor vehicle, a base part (2) is provided, on its surface side facing the interior (4) of the vehicle and suitable for the output of light, with a translucent covering layer (3). According to the invention, to improve the haptic properties, the covering layer (3) is designed to be elastically compressible and preferably translucent. The base part (2) can be designed, for example, as a plate-like optical conductor (10) which is operationally associated with a separate light generator (7), for example a light-emitting diode (8). Alternatively, it is also possible to form the base part (2) directly as a light generator (7), for example by applying an electroluminescent film (18).

### CROSS-REFERENCE TO RELATED APPLICATIONS

This application is a National Stage of application PCT/EP03/09019, filed Aug. 14, 2003, and claims priority to DE 102 40 270.1 filed Aug. 31, 2002, the disclosures of which are incorporated herein by reference in their entirety.

### FIELD

The invention relates to an element for the interior of a vehicle, in particular a motor vehicle.

### BACKGROUND

Conventional lining elements can be comprised of a lining part of the generic type for use in the interior of a motor vehicle. One exemplary embodiment comprises a transparent, light-conducting base part which, on the side of the interior of the vehicle, is equipped with a covering layer of natural stone. The natural stone is cut sufficiently thinly to permit the passage of light in order to achieve an optical effect and is joined to the base part by means of an adhesive. As an option, the covering layer can also be provided with a tacky clear varnish which, in the event of a fracture of the natural stone caused by an accident, prevents splinters flying about.

This rather exotic construction can naturally more likely be used in small, in particular narrow, components, for example decorative strips. As a result of the materials used on the side of the interior, lining parts of this kind have a hard surface with a correspondingly unpleasant feel.

Another exemplary embodiment comprises a lining element which has an elastomeric, possibly also transparent, external material which is let into a receptacle in the base part with a form fit. In order to achieve optical effects, an illumination device can be embedded in the external material.

In this construction, although a pleasing feel can be produced, the optical impression is unsatisfactory because of the locally different intensity of light. Thus, there is a need for a lining element for the interior of a vehicle that is designed such that it can both maintain a pleasing feel and provides a satisfactory optical impression.

### SUMMARY

Some embodiments provide an optically and haptically pleasing lining part, which can also be formed with a large area, having a light-emitting surface.

Some embodiments are directed to a lining element for the interior of a vehicle, in particular a motor vehicle, having a base part, and a surface side facing the interior of the vehicle, and provided with a translucent covering layer suitable for emitting light.

According to an embodiment of the invention, a lining element for the interior of a vehicle is comprised of a covering layer, a base part, and a surface side facing the interior of the vehicle and suitable for emitting light. The covering layer can be designed to be elastically compressible. Further, the covering layer can be designed to be translucent, and its optical transmissivity in the visible spectral range (generally 380 m to 780 nm., usually measured at 550 nm) may be 1 to 25%. In some embodiments, the optical transmissivity may be 5 to 10%. This translucency may be firstly sufficient in order still to emit a noticeable amount of light from the light generator into the interior of the vehicle and, secondly, may still lead to an extraordinarily uniform emission of light being achieved which can be pleasantly glare-free even in darkness.

The base part can be is designed as a plate-like optical conductor which operates in conjunction with an illumination device, for example an incandescent lamp or a light-emitting diode (LED). The optical conductor can be comprised of a transparent plastic. For instance, the optical conductor can be comprised of transparent plastics, including, but not limited to, PMMA or PC. The structure of the optical conductor can be such that light can be output on the surface side of the optical conductor, which faces the interior. Structures of this type can be produced, for example, by laser removal or sandblasting on the surface of the optical conductor, but can also be produced by structuring the mold for injection molding or in the printing process. Depending on the selected formation, the structure can be arranged on one of the two or even both the surface sides or, if appropriate, even within the optical conductor.

In some embodiments, the plate-like base part can be formed directly as a light generator and, for example, comprise an electroluminescent film (EL film). EL films are generally light-emitting films which can be cut and deformed three-dimensionally and which, as Lambert radiators, as they are known, emit virtually monochromatic light which is uniform in any viewing direction and extends from blue to yellow (480 nm to 580 nm) and also mixed colors thereof, for example white. However, other flat light emitters, for example OLEDs (organic light-emitting diodes) or polyLEDs, can also be used.

The translucent, elastically compressible covering layer can be comprised of an elastomer such as EPDM, silicone or polyurethane which, over its entire thickness or partially, has a foam structure that reduces its hardness. The elastomer can have a hardness of 20 to 70 Shore A at room temperature. This may impart to the lining element overall a pleasing feel under the atmospheric conditions prevailing in the interior of the vehicle. According to some of these embodiments, the elastomer may have a hardness of about 40 Shore A.

According to another embodiment of the invention, the covering layer can comprises a layer facing the interior of the vehicle, the layer comprised of a film and made of a gel-like substance which, at room temperature, can have a dynamic viscosity of 0.01 to 10 Pa·s, and, under local pressure being applied to the surface side of the lining element, escapes to the side in a viscid manner into the remaining gel-filled gap underneath the film.

The gel-like substance can be arranged between two films and, in this form, can be adhesively bonded to the flat base part. The film on the side of the interior can be composed such that it has a relatively low thickness, yet sufficient strength to perform its function. By way of example and not by limitation, polyurethane films with a thickness of 0.1 to 1.5 mm may be suitable. Additionally, polyurethane films with a thickness of 0.5 to 1.0 mm may be suitable.

The thickness of the covering layer, overall can be 1.0 to 5.0 mm. This may result in the edges being provided with visible and palpable curves which may optimize the overall impression of the lining element. The thickness according to some of these embodiments may be about 2.0 mm to about 3.0 mm.

### BRIEF DESCRIPTION OF THE FIGURES

The figures illustrate exemplary and schematically different embodiments of the invention.

FIG. 1 shows a longitudinal section of a lining element according to an embodiment of the invention; and

FIG. 2 shows a longitudinal section through a further lining element according to an embodiment of the invention

### DETAILED DESCRIPTION

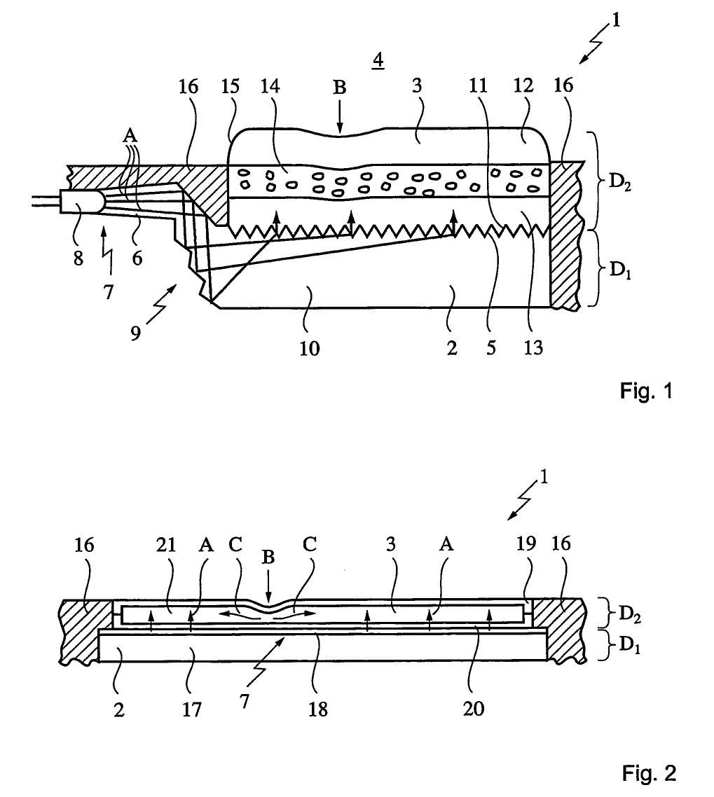

The lining element 1 illustrated in FIG. 1 can comprises a base part 2 having a thickness D₁ and a covering layer 3 having a thickness D₂. The base part 2 can be formed as an injection molding made from a transparent plastic having a structured surface 5 facing the interior 4 of the vehicle. Via an integrally molded lateral optical channel 6 (alternatively also by a glass fiber optical conductor), the light generated in a separate light generator 7 in the form of a light-emitting diode 8 (illustrated schematically by the arrows A) can be fed by a deflection zone 9 provided with mirrored surfaces and formed in the manner of a staircase into the level, flat optical conductor 10 of the base part 2, where it is distributed over the surface of the lining element 1.

Via the structured surface 5, the light can enters the covering layer 3, which can consists of a translucent elastomer and be attached to the base part 2. The covering layer can be attached to the base part by any number of suitable means including, but not limited to, being adhesively bonded by a transparent adhesive 11. The covering layer 3 can have two outer layers 12, 13 of compact material and a foamed core layer 14 of foamed material, which can extend parallel to the structured surface 5 of the base part 2. The foamed core layer 14 can increase the compressibility of the covering layer 3 and can makes the passage of light more uniform by means of scattering. Accordingly, the lining element 1 can have a uniform emergence of light and a pleasing feel, since the covering layer 3 can be deformed elastically (arrow B). The part of the covering layer 3 that projects beyond the edging 16 of the lining element 1 can have rounded edges which may reinforce the positive impression once more if they are touched.

In the embodiment of the invention according to FIG. 2, the base part 2 can comprises a flat carrier 17, which can be designed as desired with regard to its optical properties and which, on its surface side facing the interior 4 of the vehicle, can be equipped with a light generator 7. The light generator can be comprised of any suitable film. By way of example and not limitation, the light generator can be comprised of an electroluminescent film (EL Film) 18. The EL Film can generates light which enters the covering layer 3 uniformly in the direction of the arrows A.

The translucent covering layer 3 can comprise an upper and a lower translucent, flexible plastic film 19, 20, which can be joined tightly to each other at the edges. The interspace between the plastic films 19, 20 can be filled with a turbid, gel-like substance 21, which can escapes laterally (arrow C) in a viscid manner under pressure (arrow B) on the surface of the covering layer 3 that faces the interior.

Irrespective of the embodiment selected, the covering layer 3 can be comprised of a translucent surface having an optical transmissivity in the visible spectral range of 1 to 25%, in particular 5 to 10%. This translucency can firstly sufficient in order still to emit a noticeable amount of light from the light generator 7 into the interior 4 of the vehicle and, secondly, can still leads to an extraordinarily uniform emission of light being achieved which is can be pleasantly glare-free even in darkness. In some embodiments, the covering layer 3 can have translucent textile covering. In another alternative embodiment, the covering layer can be covered with a thin opaque layer which may be applied.

The lining element according to an embodiment of the invention can be designed in any desired shape and size. By way of example and not limitation, the lining element can be designed to be any one of; a three-dimensionally shaped roof linings, a door cladding, a pillar cladding, a sun visor or a rear cladding of the backrest of a vehicle seat. Illumination of the lining element can provide a pleasant ambience can be created in the entire interior of a vehicle, as an orientation light or in conjunction with operating elements.

1-15. (canceled)

16. A lining element for the interior of a vehicle, in particular a motor vehicle, a base part;
a surface side facing the interior of the vehicle and suitable for emitting light; and
a translucent covering layer wherein the covering layer is designed to be elastically compressible.

17. The lining element as claimed in claim 16, wherein the base part is a light generator.

18. The lining element as claimed in claim 17, wherein an elastomer has an at least partially foamed structure.

19. The lining element as claimed in claim 18, wherein the gel-like substance is arranged between two plastic films.

20. The lining element as claimed in claim 17, wherein the base part comprises at least electroluminescent film organic light-emitting diode and poly light-emitting diode.

21. The lining element as claimed in claim 20, wherein the translucent covering layer comprised of an elastomer that is at least one of EPDM, silicone and polyurethane.

22. The lining element as claimed in claim 21, wherein the elastomer has a hardness of 20 to 70 Shore A.

23. The lining element as claimed in claim 16, wherein the base part is designed as a plate-like optical conductor, which is operationally associated with a light generator.

24. The lining element as claimed in claim 23, wherein the optical conductor is comprised of at least one of PMMA and PC, and having a structure allowing an output of light on the surface side of the optical conductor facing the interior.

25. The lining element as claimed in claim 16, wherein the covering layer comprises a layer of a gel-like substance covered toward the interior of the vehicle by a plastic film.

26. The lining element as claimed in claim 25, wherein the plastic film on the side of the interior has a thickness of 0.1 to 1.5 mm.

27. The lining element as claimed in claim 26, wherein the covering element has a thickness overall of 1.0 to 5.0 mm.

28. The lining element as claimed in claim 25 wherein the gel-like substance has a dynamic viscosity of 0.01 to 10 Pa·s.

29. The lining element as claimed in claim 16, wherein the covering layer is designed to be translucent.

30. The lining element as claimed in claim 29, wherein the translucent covering layer has an optical transmissivity in the visible spectral range of 1 to 25%.

31. A lining element comprising:
a base part;
a surface side facing the interior of the vehicle and suitable for emitting light; and
a covering layer.

32. The lining element as claimed in claim 31, wherein the covering layer is elastically compressible.

33. The lining element as claimed in claim 31, wherein the covering layer translucent.

34. The lining element as claimed in claim 33, wherein the translucent covering layer has an optical transmissivity in the visible spectral range of 5 to 10%.

35. The lining element as claimed in claim 33, wherein the translucent covering layer comprises an elastomer comprised of an at least partially formed structure.

36. The lining element as claimed in claim 35, wherein the elastomer comprises at least one of EPDM, silicone and polyurethane.

37. The lining element as claimed in claim 35, wherein the elastomer has a hardness of approximately 40 Shore A.

38. The lining element as claimed in claim 31, wherein the covering layer comprises a layer of a gel-like substance covered toward the interior of the vehicle by means of a film.

39. The lining element as claimed in claim 38, wherein the film is comprised of plastic.

40. The lining element as claimed in claim 38, wherein the gel-like substance has a dynamic viscosity of approximately 0.1 to 1 Pa·s.

41. The lining element as claimed in claim 38, wherein the gel-like substance is arranged between two plastic films.

42. The lining element as claimed in claim 41, wherein the plastic film has a thickness of approximately 0.5 mm to approximately 1.0 mm.

43. The lining element as claimed in claim 31, wherein the covering layer has a thickness overall of approximately 2.0 mm to approximately 3.0 mm.

44. The lining element as claimed in claim 31, wherein the base plate is a plate-like optical conductor comprised of at least one of PMMA and PC.

45. The lining element as claimed in claim 31, wherein the base part is a light generator comprised of at least one of electroluminescent film, organic light-emitting diode and poly light-emitting diode.
